(19) United States
(12) Patent Application Publication
(10) Pub. No.: US 2026/0103294 A1
(43) Pub. Date: Apr. 16, 2026

(54) TECHNIQUES FOR CHARACTERIZING THE PERFORMANCE ENVELOPES OF MECHANICAL SYSTEMS USING LANGUAGE MODELS

(71) Applicant: AUTODESK, INC., San Francisco, CA (US)

(72) Inventors: Nikola Marko MARKOVIC, Surrey (GB); Daniela Sofia Seixas SOUSA, Stafford (GB); Andrew John HARRIS, London (GB); Yedige TLEGENOV, Tiburon, CA (US); Gonzalo MARTINEZ, Novato, CA (US)

(21) Appl. No.: 19/224,555

(22) Filed: May 30, 2025

Related U.S. Application Data
(60) Provisional application No. 63/707,651, filed on Oct. 15, 2024.

(51) Int. Cl. B64F 5/60; G06F 40/279; G06F 40/58

(52) U.S. Cl. CPC B64F 5/60; G06F 40/279; G06F 40/58

(57) ABSTRACT

A computer-implemented technique for characterizing performance of mechanical systems includes receiving sensor data that includes one or more measurements of a mechanical system; extracting, via a trained machine learning model, one or more values from the sensor data based on documentation associated with the mechanical system; and computing, via the trained machine learning model and based on the one or more values, one or more performance characteristics of the mechanical system.

### CROSS-REFERENCE TO RELATED APPLICATIONS

This application claims the priority benefit of U.S. Provisional Application No. 63/707,651 entitled “TECHNIQUES FOR MEASURING THE FLIGHT ENVELOPE PERFORMANCE GAP FOR AERIAL VEHICLE DESIGN” filed Oct. 15, 2024, the contents of which are incorporated by reference herein in its entirety.

### BACKGROUND

### Field of the Various Embodiments

Embodiments of the present disclosure relate generally to computer science, artificial intelligence, and machine learning, and, more specifically, to techniques for characterizing the performance envelopes of mechanical systems using language models.

### Description of the Related Art

Characterizing and measuring the performance boundaries of mechanical systems plays a vital role in ensuring the safety and efficiency of those mechanical systems. A performance envelope represents the safe and acceptable range of operation for a mechanical system. For example, a flight envelope for an aircraft, such as an unmanned aerial vehicle (UAV), could show the limits of airspeed and altitude within which the aircraft can fly safely, without experiencing structural failure or performance degradation. As another example, a performance envelope for a pump, engine, or other mechanical component could define the operating range, such as the pressure, flow rate, and/or power output within which the mechanical component can be operated without damage or inefficiency.

Conventional approaches for characterizing the performance envelopes of mechanical systems oftentimes rely heavily on theoretical modeling and manual interpretation of data from sensors on those mechanical systems. Some mechanical systems generate extensive amounts of sensor data due to high-frequency logging of sensor data and/or multiple onboard sensors. Integrating and analyzing the large datasets can require specialized expertise in data science or signal processing, particularly when each sensor stream uses unique naming conventions, sampling rates, or file formats. In some instances, analyzing the sensor data can require expertise in multiple domains, such as aerospace, signal processing, and software engineering.

Therefore, manually collecting and analyzing the sensor data to characterize the performance envelopes of mechanical systems can be very complicated, leading to potential increased efforts, underutilized data, and errors. Further, no technical infrastructure currently exists for automatically characterizing the performance envelopes of mechanical devices. As a result, mechanical systems can be designed with suboptimal operational safety or reliability.

As the foregoing illustrates, what is needed in the art are more effective techniques for characterizing the performance envelopes of mechanical systems.

### SUMMARY

One embodiment sets forth a method for characterizing performance envelopes of mechanical systems. The method includes receiving sensor data that includes one or more measurements of a mechanical system. The method further includes extracting, via a trained machine learning model, one or more values from the sensor data based on documentation associated with the mechanical system. In addition, the method includes computing, via the trained machine learning model and based on the one or more values, one or more performance characteristics of the mechanical system.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques over the prior art is that the disclosed techniques provide the technical infrastructure for automatically retrieving relevant sensor data, cleaning the sensor data, and computing performance envelopes for mechanical systems using the cleaned sensor data. As a result, discrepancies between theoretical and actual performance behavior can be identified, and mechanical systems can be designed and implemented with improved operational safety and reliability. Another technical advantage is that the disclosed techniques facilitate scalability when incorporating varied sensors or novel mechanical system configurations. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the server device of FIG. 1, according to various embodiments;

FIG. 3 is a more detailed illustration of the computing device of FIG. 1, according to various embodiments;

FIG. 4 is a more detailed illustration of the server application of FIG. 1, according to various embodiments;

FIG. 5A illustrates how an exemplar user input can be handled to extract data from technical documentation, according to various embodiments;

FIG. 5B illustrates how an exemplar user input can be handled for plotting a theoretical flight envelope, according to various embodiments;

FIG. 5C illustrates how an exemplar user input can be handled for plotting flight performance, according to various embodiments;

FIG. 6 is a flow diagram of method steps for processing user inputs to generate output, according to various embodiments; and

FIG. 7 is a flow diagram of method steps for analyzing sensor data using a generative AI model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

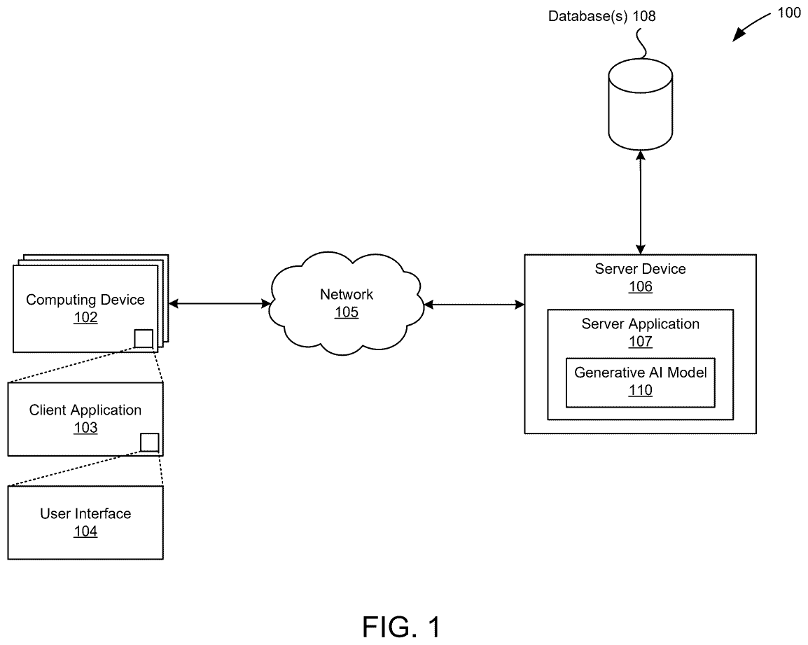

FIG. 1 is a conceptual illustration of a system 100 configured to implement one or more aspects of the various embodiments. As shown, the system 100 includes a computing device 102, a server device 106, and one or more databases 108. The computing device 102 and the server device 106 communicate via a communications network 105. The communications network 105 can represent, for example, any technically feasible network or combination of networks, including a wide area network (WAN), a local area network (LAN), a Wi-Fi network, a cellular network, or the like.

Although described with respect to a single computing device 102 for simplicity, in some embodiments, the server device 106 can serve client applications running on any number of computing devices.

In some embodiments, the computing device 102 can be a desktop computing device, a laptop computing device, a mobile computing device, or the like. As shown, a client application 103 executes on the computing device 102. The client application 103 provides a user interface 104 through which users can submit questions, commands, sensor data, and/or other data.

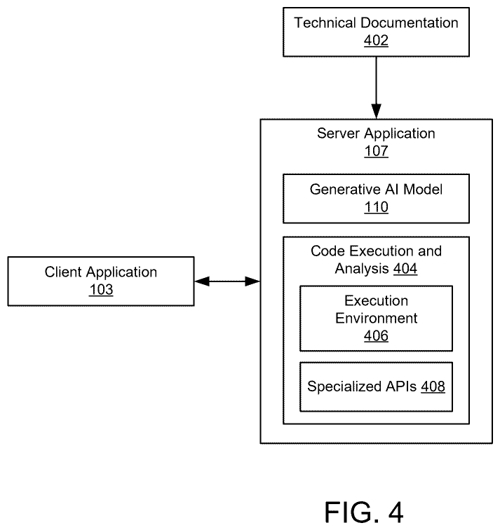

In some embodiments, the client application 103 is configured to receive, via the user interface 104, data that is input by a user, and the client application 103 transmits the input data to the server device 106 for analysis. In particular, the client application 103 can receive sensor data, technical specifications, and/or user inputs (e.g., design criteria, user questions, or performance metrics) relevant to a mechanical system, such as an unmanned ariel vehicle (UAV), and the client application 103 can transmit such data to the server device 106 for processing via the techniques described in greater detail below in conjunction with FIGS. 4-7.

In some embodiments, given user inputs and/or sensor data from the client application 103, a server application 107 executing on the server device 106 can employ the generative AI model 110 to generate output. The server application 107 can then transmit, to the client application 103, the generated outputs. Returning to the UAV example, the generated outputs could include flight envelope plots, performance metrics, performance envelope analyses, and/or the like. As shown in FIG. 1, the server device 106 can also interface with one or more databases 108 that are implemented by the server device 106 and/or other entities not illustrated in FIG. 1. The databases 108 can store technical documentation, sensor data, operational data logs, and/or other information for use by the generative AI model 110.

Given outputs generated by the generative AI model 110, the client application 103 can display the generated outputs via the user interface 104 or in any other suitable manner. In some embodiments, the client application 103 can be configured to display various simulations, visualizations, and/or textual output that illustrate system performance under different operational conditions and/or design modifications. For example, a user could use the client application 103 to review the performance envelope plots or analyze different performance metrics over time or under different operational conditions.

It will be appreciated that the computing device 102, the server device 106, the databases 108, and the generative AI model 110 described in conjunction with FIG. 1 are illustrative, and that variations and modifications are possible. The connection topologies may be modified as desired, and, in certain embodiments, one or more components shown in FIG. 1 may not be present, or may be combined into fewer components. For example, in some embodiments, the computing device 102 can be configured to implement some aspects of the disclosed techniques. Further, in certain embodiments, one or more components shown in FIG. 1 may be implemented as virtualized resources in one or more virtual computing environments and/or cloud computing environments.

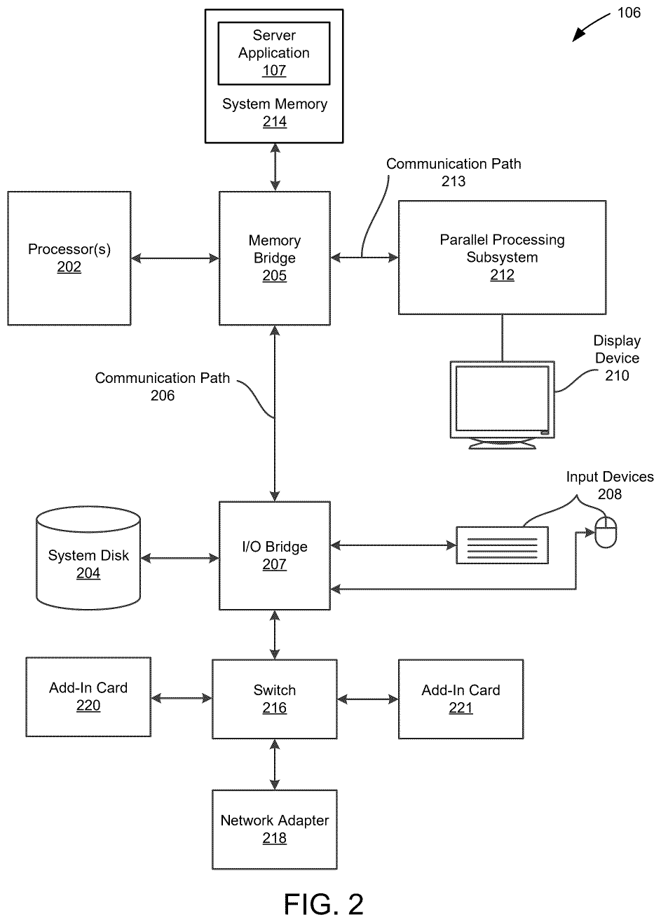

FIG. 2 is a more detailed illustration of the server device 106 of FIG. 1, according to various embodiments. The server device 106 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the server device 106 is a server machine operating in a data center or a cloud computing environment that provides scalable computing resources as a service over a network.

As shown, the server device 106 includes, without limitation, processor(s) 202 and system memory 214 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 202 for processing. In some embodiments, the server device 106 may be a server machine in a cloud computing environment. In such embodiments, the server device 106 may not include input devices 208, but may receive equivalent input information by receiving commands (e.g., responsive to one or more inputs from a remote computing device) in the form of messages transmitted over a network and received via the network adapter 218. In some embodiments, the switch 216 is configured to provide connections between the I/O bridge 207 and other components of the server device 106, such as a network adapter 218 and various add-in cards 220 and 221.

In some embodiments, the I/O bridge 207 is coupled to a system disk 204 that may be configured to store content and applications and data for use by processor(s) 202 and the parallel processing subsystem 212. In some embodiments, the system disk 204 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the server device 106, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 214 includes at least one device driver configured to manage the processing operations of the one or more PPUs within the parallel processing subsystem 212. In addition, the system memory 214 includes the server application 107. Although described herein primarily with respect to the server application 107, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system.

For example, the parallel processing subsystem 212 may be integrated with the processor(s) 202 and other connection circuitry on a single chip to form a system on a chip (SoC).

In some embodiments, the processor(s) 202 includes the primary processor of server application 107, controlling and coordinating operations of other system components. In some embodiments, the processor(s) 202 issue commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 202, and the number of parallel processing subsystems 212, may be modified as desired. For example, in some embodiments, the system memory 214 could be connected to the processor(s) 202 directly rather than through the memory bridge 205, and other devices may communicate with the system memory 214 via the memory bridge 205 and the processor(s) 202. In other embodiments, the parallel processing subsystem 212 may be connected to the I/O bridge 207 or directly to the processor(s) 202, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. For example, the parallel processing subsystem 212 may be implemented as a virtualized parallel processing subsystem in at least one embodiment. As a specific example, the parallel processing subsystem 212 may be implemented as virtual graphics processing unit(s) (vGPU(s)) that render graphics on a virtual machine(s) (VM(s)) executing on server machine(s) whose GPU(s) and other physical resources are shared across one or more VMs.

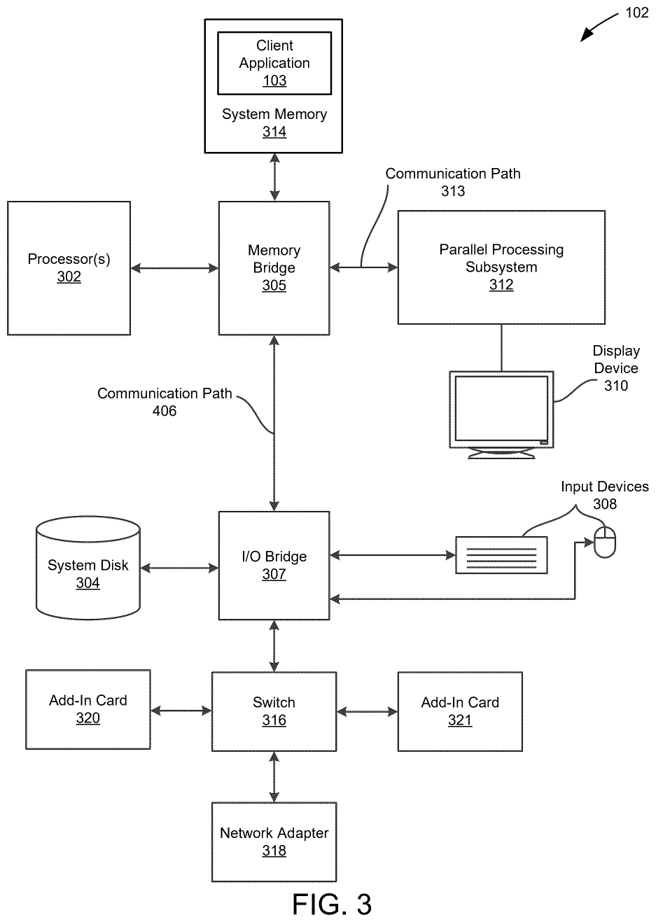

FIG. 3 is a more detailed illustration of the computing device 102 of FIG. 1, according to various embodiments. The computing device 102 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 102 is a server machine operating in a data center or a cloud computing environment that provides scalable computing resources as a service over a network.

As shown, the computing device 102 includes, without limitation, processor(s) 302 and system memory 314 coupled to a parallel processing subsystem 312 via a memory bridge 305 and a communication path 313. The memory bridge 305 is further coupled to an I/O bridge 307 via a communication path 306, and the I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 302 for processing. In some embodiments, the computing device 102 may be a server machine in a cloud computing environment. In such embodiments, the computing device 102 may not include the input devices 308, but may receive equivalent input information by receiving commands (e.g., responsive to one or more inputs from a remote computing device) in the form of messages transmitted over a network and received via the network adapter 318. In some embodiments, the switch 316 is configured to provide connections between the I/O bridge 307 and other components of the computing device 102, such as a network adapter 318 and various add-in cards 320 and 321.

In some embodiments, the I/O bridge 307 is coupled to a system disk 304 that may be configured to store content and applications and data for use by the processor(s) 302 and the parallel processing subsystem 312. In some embodiments, the system disk 304 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, the communication paths 306 and 313, as well as other communication paths within the computing device 102, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more PPUs, also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 314 includes at least one device driver configured to manage the processing operations of the one or more PPUs within the parallel processing subsystem 312. In addition, the system memory 314 includes the client application 103. Although described herein primarily with respect to the client application 103, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with the processor(s) 302 and other connection circuitry on a single chip to form a SoC.

In some embodiments, the processor(s) 302 includes the primary processor of the computing device 102, controlling and coordinating operations of other system components. In some embodiments, the processor(s) 302 issue commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 302, and the number of parallel processing subsystems 312, may be modified as desired. For example, in some embodiments, the system memory 314 could be connected to the processor(s) 302 directly rather than through the memory bridge 305, and other devices may communicate with the system memory 314 via the memory bridge 305 and the processor(s) 302. In other embodiments, the parallel processing subsystem 312 may be connected to the I/O bridge 307 or directly to the processor(s) 302, rather than to the memory bridge 305. In still other embodiments, the I/O bridge 307 and the memory bridge 305 may be integrated into a single chip instead of existing as one or more discrete devices. In certain embodiments, one or more components shown in FIG. 3 may not be present. For example, the switch 316 could be eliminated, and the network adapter 318 and the add-in cards 320, 321 would connect directly to the I/O bridge 307. Lastly, in certain embodiments, one or more components shown in FIG. 3 may be implemented as virtualized resources in a virtual computing environment, such as a cloud computing environment. For example, the parallel processing subsystem 312 may be implemented as a virtualized parallel processing subsystem in at least one embodiment. As a specific example, the parallel processing subsystem 312 may be implemented as virtual graphics processing unit(s) (vGPU(s)) that render graphics on a virtual machine(s) (VM(s)) executing on server machine(s) whose GPU(s) and other physical resources are shared across one or more VMs.

### Characterizing the Performance Envelopes of Mechanical Systems Using Language Models

FIG. 4 is a more detailed illustration of the server application 107 of FIG. 1, according to various embodiments. As shown, the server application 107 includes, without limitation, the generative AI model 110 and a code execution and analysis module 404. The code execution and analysis module 404 includes, without limitation, an execution environment 406 and specialized application programming interfaces (APIs) 408. Illustratively, the server application 107 is in communication with the client application 103 and has access to technical documentation 402.

In operation, the client application 103 can receive inputs, such as sensor data, technical specifications, and/or user inputs (e.g., design criteria, user inputs, performance metrics, etc). The client application 103 transmits the inputs to the server application 107 for further processing. For example, the client application 103 could transmit sensor data from a UAV or other mechanical system, along with a user question (e.g., “What is the performance envelope?”), to the server application 107. As used herein, a mechanical system can include a collection of physical components that interact to perform one or more functions. A mechanical system can be equipped with one or more internal combustion engines, electric propulsion systems, or hybrid power systems. A mechanical system can also be an electrically driven device, such as a battery-powered motor. Given the inputs from the client application 103, the server application 107 employs the generative AI model 110 to generate output (e.g., performance envelope plots, retrieved performance metrics, etc.), which the server application 107 transmits back to the client application 103 for display to a user. For example, in some embodiments, the generated output can include various simulations, generated visualizations, and/or textual output that illustrate performance of a mechanical system under different operational conditions or design modifications. As a specific example the generated output could include sensor-based flight envelope plots overlaid with theoretical flight envelope over time or under different operational conditions.

The technical documentation 402 can include one or more domain-specific references, guidelines, and/or performance metrics related to one or more mechanical systems, such as UAVs. For example, in some embodiments, the reference(s) stored in technical documentation 402 can include mechanical systems operating manuals, engineering guidelines, and/or the like. In some embodiments, the technical document 402 specifies units for various measurements. In some embodiments, the server application 107 can also have access to resources other than technical document 402. For example, in some embodiments, the server application 107 can access a server that is able to compute theoretical performance envelopes for the server application 107.

The server application 107 is configured to handle various user inputs from the client application 103. In some embodiments, the user inputs can include, for example, inputs asking the server application 107 to specify design criteria, calculate a flight envelope from sensor data, extract specific sensor data such as acceleration or g-load factor, retrieve performance metrics, and/or other tasks. Given a user input, the server application 107 can generate a prompt and input the prompt into the generative AI model 110, causing the generative AI model 110 to perform actions to generate an output in response to the request. For example, the actions could include domain-specific computations (e.g., computing a performance envelope requested by the user input), retrieving performance metrics, generating program code for execution, and/or requesting analytics from code execution and analysis module 404. The server application 107 can then provide output that is generated by the generative AI model 110 back to the client application 103.

The generative AI model 110 includes one or more trained machine learning models that are able to analyze sensor data, compute performance envelopes, generate code, and generate textual output based on received user inputs. For example, the trained machine learning model(s) can include one or more language models (e.g., a large language model), multimodal models, reasoning models, and/or the like. It is noted that the foregoing examples are not meant to be limiting, and the generative AI model 110 can include any technically feasible machine learning model(s) that are trained based on any amount, type, form, etc., of information, at any level of granularity, consistent with the scope of this disclosure. In some embodiments, the generative AI model 110 can interpret user inputs, map domain-specific phrases in the user input to relevant terms from the technical documentation 402, convert the relevant terms to the names of fields in sensor data, extract data associated with the fields from the sensor data, and analyze the extracted data (to, e.g., compute a performance envelope). The technical documentation 402 can be provided to the generative AI model 110 in any technically feasible manner, such as embedded within a prompt or as a vector database that the generative AI model 110 can query. In some embodiments, the generative AI model 110 can perform retrieval-augmented generation (RAG) to retrieve the relevant terms from the technical documentation 402 and utilize the retrieve terms to generate an output. By translating the domain-specific phrases into corresponding sensor data fields, the generative AI model 110 is able to extract relevant data from the sensor data. For example, the user input could reference high-level concepts or performance metrics (e.g., pitch rate or g-load factor), which are then mapped by the generative AI model 110 to the precise fields and metrics needed for performance envelope computation or other requested tasks. In some embodiments, to enable the generative AI model 110 to perform such a translations, the server application 107 can generate and input into the generative AI model 110 a prompt that includes (1) a description of the sensor data, (2) one or more rules specifying how terms in the technical documentation 402 can be translated into fields in the sensor data, and an (3) instruction to use the technical documentation 402 to determine one or more fields in the sensor data for extracting the data values, among other things. In some embodiments, the prompt can also include a system message (also referred to as a “system prompt”) that includes a set of rules for processing the sensor data, such as functions to call. In some embodiments, the prompt can employ a ‘chain of thought’ prompting approach and include detailed steps and necessary constraints to process raw sensor data.

In some embodiments, the generative AI model 110 can also generate program code and transmit the generated code for execution by the code execution and analysis module 404. For example, the generative AI model 110 could generate program code for computing a performance envelope given sensor data and a user input asking for the performance envelope. The code execution and analysis module 404 includes execution environment 406 and specialized APIs 408. Although shown as being included in the server application 107 for illustrative purposes, the code execution and analysis module 404 or functionality thereof can be implemented elsewhere (e.g., in another server or cloud computing environment) and accessible to the server application 107 in some embodiments. The code execution and analysis module 404 enables analysis of mechanical system performance by integrating execution of program code that is generated by the generative AI model 110 with domain-specific functionalities. In some embodiments, code execution and analysis module 404 can allow on-demand calculations, data transformations, and/or visualizations.

In some embodiments, the execution environment 406 in the code execution and analysis module 404 can generate and/or manage isolated runtime containers to handle computational tasks in parallel. In such cases, generated program code can be executed in the execution environment 406.

In some embodiments, the specialized APIs 408 enable domain-specific functionalities relevant to mechanical systems applications. For example, in some embodiments, specialized APIs 408 can implement sensor data cleaning algorithms, signal processing routines, and/or performance envelope plot generation techniques. The specialized APIs 408 can be called by program code that is generated by generative AI model 110 and is executed within the execution environment 406, enabling real time analysis of sensor data and/or other performance metrics. Additionally, in some embodiments, the specialized APIs 408 can interface with external repositories and/or databases that include engineering standards, regulatory guidelines, technical specifications, and/or the like.

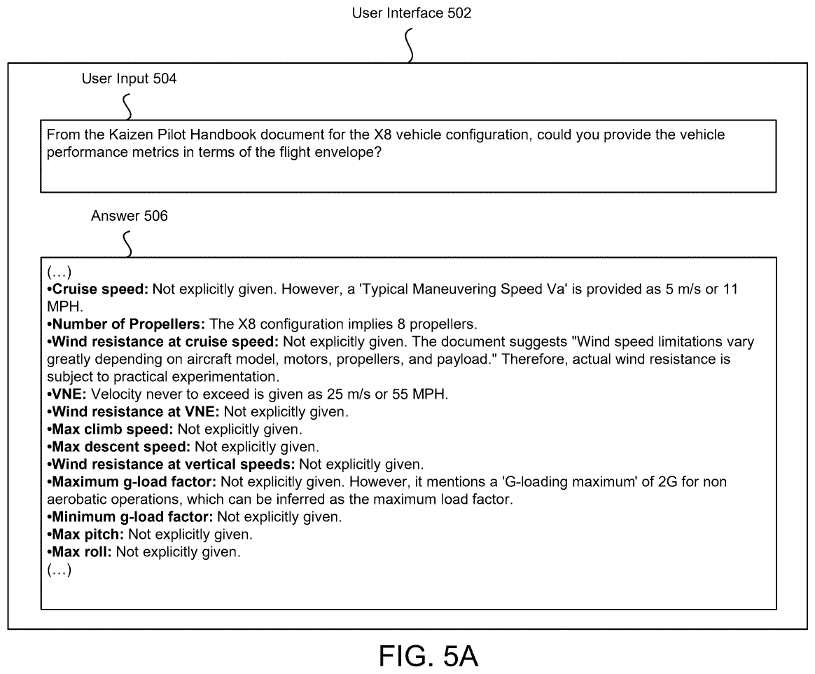

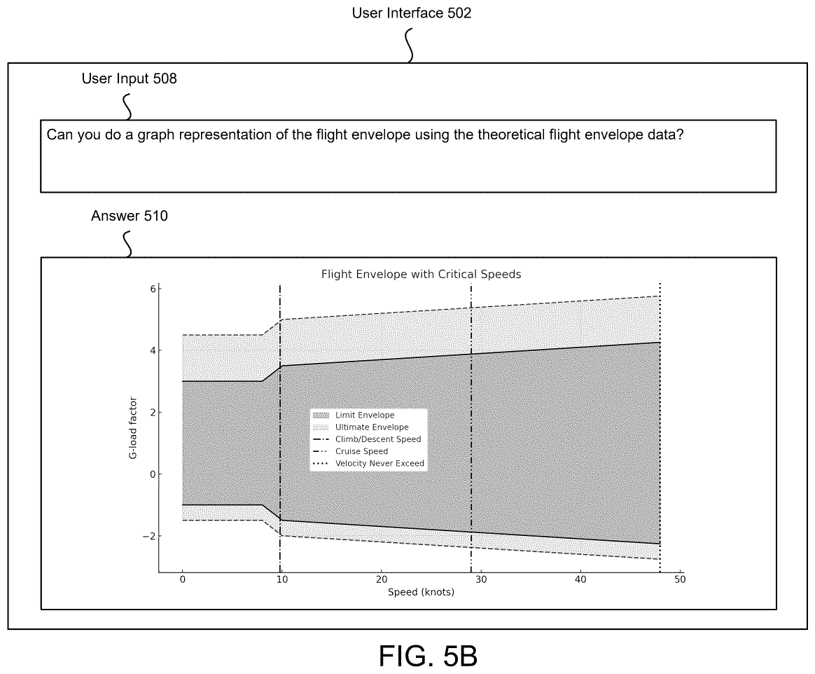

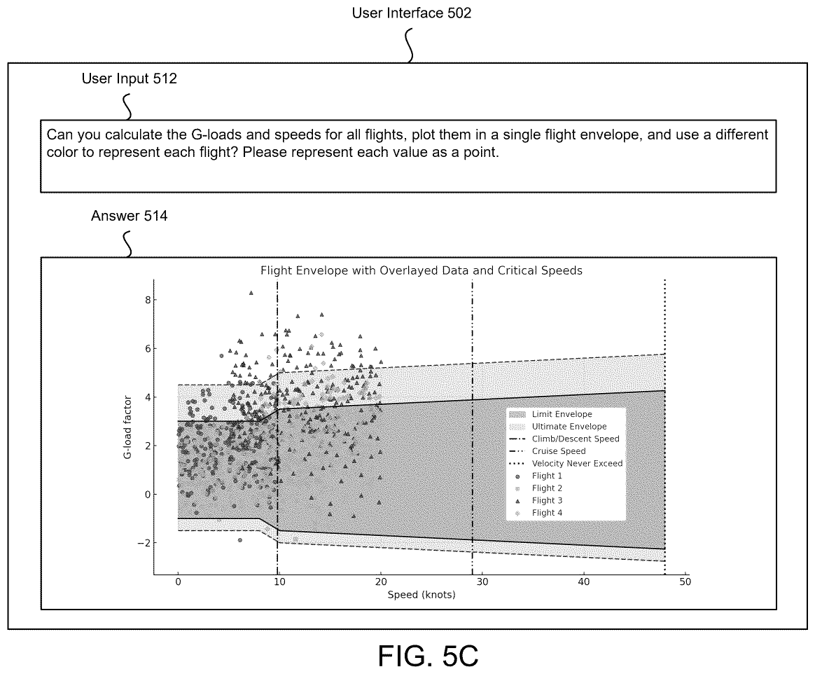

FIG. 5A illustrates how an exemplar user input can be handled to extract data from technical documentation, according to various embodiments. As shown, a user interface 502, which can correspond to the user interface 104 is displayed to a user by the client application 103. In the user interface 502, the user has entered a user input 504 that includes a query referencing a Kaizen Pilot Handbook document for an X8 vehicle configuration, requesting vehicle performance metrics in terms of the flight envelope.

In some embodiments, the client application 103 transmits the user input 504 to the server application 107. Then, the server application 107 prompts the generative AI model 110 to perform RAG to identify relevant technical terms in the document specified by he user input 504 and retrieve domain-specific terms from relevant technical documentation 402. The generative AI model 110 outputs the relevant technical terms in a generated text output, which the server application 107 transmits to the client application 103, and the generated textual output is displayed by the client application 103 via the user interface 502, shown as answer 506 that is display via user interface 502.

As shown, the answer 506 presents a text-based response that lists various performance metrics identified in the referenced technical documentation. For example, answer 506 specifies a number of propellers, a velocity never to exceed (VNE), and maximum g-load factors. The textual output shown in answer 506 may omit certain performance metrics when the technical documentation does not provide explicit values such as wind resistance at VNE, indicating the need to rely on other data sources or specialized APIs 408 to give an answer such as cruise speed. The user interface 502 organizes a text input field into which the user input 504 is entered and a text output field that displays the answer 506 in a structured layout, enabling a user to review documented performance metrics alongside requested data.

FIG. 5B illustrates how an exemplar user input can be handled for plotting a theoretical flight envelope, according to various embodiments. As shown, in the user interface 502, a user has entered a user input 508 that includes a query requesting a graphical representation of flight envelope data derived from theoretical flight envelope data.

In response to the user input 508, the server application 107 uses the generative AI model 510 to generate an output that is transmitted back to the client application 103 and display as an answer 510. As shown, the answer 610 is presented as a plotted chart of speed (knots) on the horizontal axis and g-load factor on the vertical axis. Limit envelope boundaries are indicated by solid lines, and ultimate envelope boundaries are indicated by dashed lines. In addition, climb/descent speed indicated by dash-dot line, cruise speed indicated by dash-double-dot line, and velocity never exceed (VNE) limit is shown by dotted line. The visual distinctions allow a user to identify safe operating zones and critical speed thresholds.

As described, in some embodiments, the server application 107 inputs, into the generative AI model 110, prompt instructing the generative AI model 110 to retrieve domain-relevant terms, translates the relevant terms into plot parameters, and generate program code for producing the visualization. Code execution and analysis module 404 within server application 107 can execute the generated code, call specialized APIs 408 for mathematical operations, and return plot data or image files, which can be output by the generative AI model 110 and transmitted by the server application 107 to the client application 103 for display via the user interface 502. For example, in some embodiments, the generative AI model 110 can call an external server that provides a web service for computing theoretical flight envelopes and returns a result to the server application 107, and the generative AI model 110 can then generate code for plotting the results as a graph and use the code execution and analysis module 404 to execute the generated code.

FIG. 5C illustrates how an exemplar user can be handled for plotting flight performance, according to various embodiments. As shown, a user has entered, via, user interface 502 a user input 512 that includes a query requesting calculation of g-loads and speeds for multiple flights together in a single flight envelope. The query specifies that each flight be represented using a distinct color scheme, with each data point shown as a unique shape on the graph.

In response to the user input 512, Illustratively, the answer 506 is a plotted chart that overlays experimental flight data points on the theoretical flight envelope described in FIG. 5B. As shown, speed (knots) appears on the horizontal axis, and g-load factor appears on the vertical axis. Furthermore, different shapes such as circles, triangles, squares, and diamonds are used to indicate distinct data from each flight, with color variations distinguishing data points within the plot. The limit envelope boundaries (solid lines) and ultimate envelope boundaries (dashed lines), along with climb/descent speed (dash-dot line), cruise speed (dash-double-dot line), and velocity never exceed (dotted line) are indicated within answer 506.

As shown, the plotted data in the answer 514 enables a simultaneous view of theoretical operating limits and actual measured flight data. The generative AI model 110 processes the user input 512, and retrieves required flight data from logged sensor data within databases 108 or elsewhere. Then, the generative AI model 110 generates program code and causes the code execution and analysis module 404 to execute the program code to generate the overlayed plot, calling specialized APIs 408 as needed for statistical computations and/or data cleaning.

As shown, the answer 514 allows a user to compare real operational sensor data with theoretical constraints. In addition, the differences between measured data points and theoretical envelopes can guide further data collection, or prompt iterative updates to system models or design criteria. Data points displayed in the answer 514 can also reveal operational regions within safe margins or show edge cases that necessitate additional investigation.

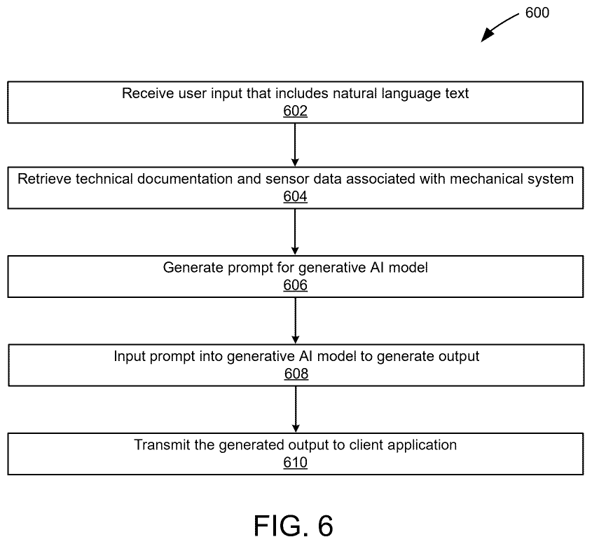

FIG. 6 is a flow diagram of method steps for processing user inputs and generating prompts, according to various embodiments. Although the method steps are described with reference to the systems of FIGS. 1-4, persons skilled in the art will understand that any system configured to implement the method steps, in any order, falls within the scope of the present disclosure.

As shown, a method 600 begins at step 602, where the server application 107 receives a user input that includes natural language text relating to a mechanical system. The user input can be received via user interface 104 of client application 103 executing on computing device 102. The user input can include references to sensor data, performance envelope, and/or other parameters.

At step 604, the server application 107 retrieves technical documentation and sensor data associated with the mechanical system from the one or more databases 108, technical documentation 402, and/or other accessible storage locations. The retrieved documentation and sensor data can include operating manuals, logged sensor data associated with a mechanical system, specification data, and/or the like.

At step 606, the server application 107 generates a prompt for the generative AI model 110 that includes the received user request and the retrieved documentation and sensor data. In some embodiments, the retrieved documentation can be embedded as text within the prompt or, alternatively, the technical documentation can be stored in a vector database that the generative AI model 110 can query. In the prompt, the server application 107 can also embed domain-specific references, data field mappings, and instructions that specify data cleaning or interpolation procedures. The prompt can further indicate computational techniques such as identifying relevant sensor parameters, executing specialized calculations, and referencing specialized APIs 408. For example, in some embodiments, the prompt can include (1) a description of the sensor data, (2) one or more rules specifying how terms in the technical documentation can be translated into fields in the sensor data, and an (3) instruction to use the technical documentation to determine one or more fields in the sensor data for extracting the data values, among other things. In some embodiments, the prompt can also include a system message (also referred to as a “system prompt”) that includes a set of rules for processing the sensor data, such as functions to call. In some embodiments, the prompt can employ a ‘chain of thought’ prompting approach and include detailed steps and necessary constraints to process raw sensor data. In some embodiments, the prompt can instruct the generative AI model 110 to generate code designed for execution within the code execution and analysis module 404.

At step 608, the server application 107 inputs the generated prompt into the generative AI model 110 to generate an output. The generative AI model 110 can process domain-specific instructions, sensor data, and technical documentation according to the prompt. The server application 107 can optionally call code execution and analysis module 404 to perform signal processing, execute generated program code, and/or apply specialized APIs 408 for calculations and/or data transformations. The generated output can include calculated performance metrics, textual answers, graphical outputs such as plots of performance envelopes, and/or the like.

At step 610, the server application 107 transmits the generated output to the client application 103 for display within the user interface 104 or elsewhere. For example, the displayed output could include performance envelope plots overlaid with sensor data, calculated g-load factors, computed speed profiles, and/or the like. The user can review, interact with, and/or store the displayed data for further analysis or refinement. Although described herein primarily with respect to displaying the generated output as a reference example, the generated output can be further processed in any suitable manner in some embodiments. For example, in some embodiments, the generated output can be used to evaluate if a mechanical system meets specific criteria or predefined performance metrics.

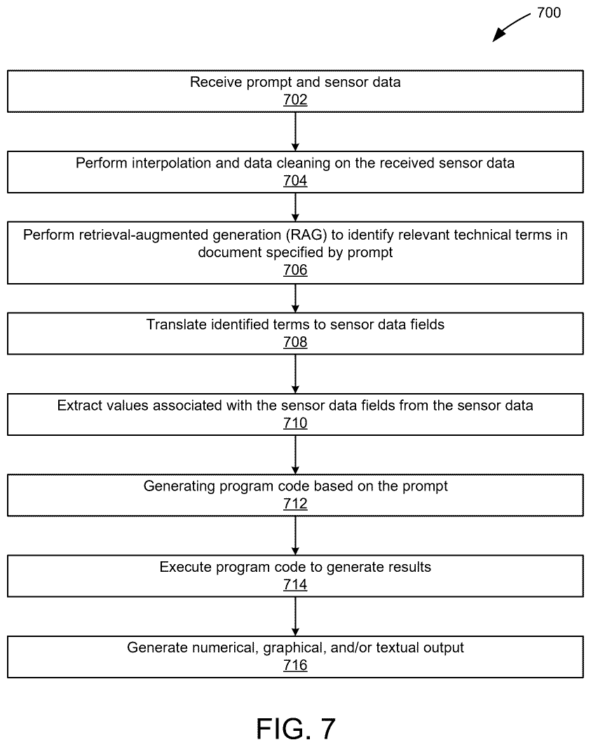

FIG. 7 is a flow diagram of method steps for analyzing sensor data using a generative AI model, according to various embodiments. Although the method steps are described with reference to the systems of FIGS. 1-4, any system configured to implement the method steps in any order falls within the scope of the present disclosure.

As shown, a method 700 begins at tep 702, where the generative AI model 110 receives a prompt and associated sensor data from the server application 107. The prompt can include a user input requesting performance metrics and/or other performance analyses for a mechanical system, such as an unmanned aerial vehicle. In some embodiments, the prompt can include prompt generated by the server application 107 at step 606 of the method 600, described above in conjunction with FIG. 6. Steps 704-716 are performed by the generative AI model 110 according to the prompt. The sensor data can include any sensor data collected during operation of a mechanical system, such as cruise speed, acceleration, g-load factor, and/or other operational logs stored in the databas(es) 108 or elsewhere. In some embodiments, the sensor data can be included in the prompt, specified by the prompt, stored in a file, retrieved from the database(s) 108, or obtained in any other technically feasible manner.

At step 704, the generative AI model 110 performs interpolation and data cleaning on the received sensor data. The server application 107 can call specialized APIs 408 to perform time-series analysis, signal processing, data cleaning, and/or other processing techniques on the received sensor data. The execution environment 406 can execute code scripts that remove noisy data points, fill in missing values, and/or align disjointed sampling rates. The resulting data provides consistent input for further computation or analysis.

At step 706, the generative AI model 110 employs retrieval-augmented generation (RAG) to identify relevant technical terms in technical documentation specified by the prompt. The generative AI model 110 can search technical documentation, including domain-specific references, guidelines, and/or performance metrics related to mechanical systems, to locate relevant terms. The relevant terms can be selected for subsequent mapping to sensor data fields based on instructions in the received prompt.

At step 708, the generative AI model 110 translates the identified relevant terms to sensor data fields. The generative AI model 110 can convert the relevant terms to naming conventions found in sensor logs or parameter files stored in databases 108 according to instructions in the received prompt. Such a translation enables domain-specific terms like “pitch rate” or “climb speed” to be mapped to fields, such as columns or keys, in the cleaned sensor data.

At step 710, the generative AI model 110 extracts values associated with the translated sensor data fields from the cleaned sensor data. For example, the extracted values could include time-stamped readings, min-max ranges, and/or aggregated statistics corresponding to each domain-specific term. The generative AI model 110 can further analyze or refine the extracted values before generating outputs or performing calculations.

At step 712, the generative AI model 110 generates program code based on the prompt. The generative AI model 110 can generate scripts or other program code for performing the requested computational tasks in the prompt, such as flight envelope plotting, signal processing, or statistical modeling. The server application 107 or prompt can include directives for referencing specialized APIs 408, allowing generated code to utilize domain-specific functions or processes for computations and/or visualizations.

At step 714, the generative AI model 110 causes the generated program code to be executed to generate results. The generative AI model 110 can invoke the code execution and analysis module 404 to execute the program code in the execution environment 406. The generated results, such as data structures, performance metrics, and/or data visualizations, can be compiled for display or further manipulation. In some embodiments, the program code can call specialized APIs 408 to perform domain-specific calculations, such as performance envelope plotting or signal processing. Execution environment 206 can allocate memory resources, manage concurrency, and handle dependencies required for program code execution.

At step 716, based on the execution results of step 714, the generative AI model 110 generates numerical, graphical, and/or textual output for presentation to a user. The generated output can include performance envelope plots, performance envelope analyses, recommended operating limits of a mechanical system, and/or the like. The server application 107 can then transmit the generated output to client application 103 for display to a user via the user interface 104. The displayed output can assist the user in evaluating mechanical system performance, monitoring performance metrics, or refining design criteria. The displayed metrics and visualizations can be stored in databases 108 for subsequent retrieval, enabling ongoing iterations of system analysis or design modification.

In sum, techniques are disclosed for characterizing performance envelopes and analyzing performance metrics of mechanical systems through a combination of large language models, domain knowledge retrieval, code execution environments, data cleaning, and specialized APIs. In some embodiments, a performance characterization application receives sensor data associated with a mechanical system and a natural language input, such as a question, from a user. The performance characterization application generates a prompt that includes the natural language input and a system message that includes (1) a description of the sensor data; (2) rules specifying how terms in documentation for the mechanical system are translated into fields in the sensor data; and (3) instructions for responding to the natural language input, such as cleaning the sensor data and using the documentation to determine relevant fields whose data should be extracted from the sensor data. The performance characterization application inputs the prompt into a trained language model that uses retrieval augmented generation (RAG) to extract relevant data from the sensor data, performs computations such as calculating a performance envelope, and generates a graphical representation of the computation results.

One technical advantage of the disclosed techniques over the prior art is that the disclosed techniques provide the technical infrastructure for automatically retrieving relevant sensor data, cleaning the sensor data, and computing performance envelopes for mechanical systems using the cleaned sensor data. As a result, discrepancies between theoretical and actual performance behavior can be identified, and mechanical systems can be designed and implemented with improved operational safety and reliability. Another technical advantage is that the disclosed techniques facilitate scalability when incorporating varied sensors or novel mechanical system configurations. These technical advantages provide one or more technological improvements over prior art approaches.

1. In some embodiments, a computer-implemented method for characterizing performance of mechanical systems comprises receiving sensor data that includes one or more measurements of a mechanical system, extracting, via a trained machine learning model, one or more values from the sensor data based on documentation associated with the mechanical system, and computing, via the trained machine learning model and based on the one or more values, one or more performance characteristics of the mechanical system.

2. The computer-implemented method of clause 1, further comprising receiving a natural language input, wherein extracting the one or more values from the sensor data is further based on the natural language input.

3. The computer-implemented method of clauses 1 or 2, wherein extracting the one or more values comprises retrieving one or more terms from the documentation based on natural language input, translating the one or more terms into one or more fields, and extracting the one or more values from the sensor data based on the one or more fields.

4. The computer-implemented method of any of clauses 1-3, wherein computing the one or more performance characteristics comprises generating program code, and executing the program code to compute the one or more performance characteristics.

5. The computer-implemented method of any of clauses 1-4, wherein extracting the one or more values comprises inputting a prompt into the trained machine learning model, and wherein the prompt comprises a description of the sensor data, one or more rules specifying how terms in the documentation are translated into fields in the sensor data, and an instruction to use the documentation to determine one or more fields in the sensor data for extracting the one or more values.

6. The computer-implemented method of any of clauses 1-5, further comprising interpolating, by the trained machine learning model, at least two values in the sensor data.

7. The computer-implemented method of any of clauses 1-6, wherein the one or more performance characteristics include a performance envelope.

8. The computer-implemented method of any of clauses 1-7, wherein the documentation specifies one or more units for one or more measurements.

9. The computer-implemented method of any of clauses 1-8, further comprising retrieving, by the trained machine learning model, one or more theoretical performance characteristics.

10.The computer-implemented method of any of clauses 1-9, wherein the trained machine learning model comprises a trained large language model (LLM).

11.In some embodiments, one or more non-transitory computer-readable media store instructions that, when executed by at least one processor, cause the at least one processor to perform the steps of receiving sensor data that includes one or more measurements of a mechanical system, extracting, via a trained machine learning model, one or more values from the sensor data based on documentation associated with the mechanical system, and computing, via the trained machine learning model and based on the one or more values, one or more performance characteristics of the mechanical system.

12.The one or more non-transitory computer-readable media of clause 11, wherein the instructions, when executed by the at least one processor, further cause the at least one processor to perform the step of receiving a natural language input, wherein extracting the one or more values from the sensor data is further based on the natural language input.

13.The one or more non-transitory computer-readable media of clauses 11 or 12, wherein extracting the one or more values comprises retrieving one or more terms from the documentation based on natural language input, translating the one or more terms into one or more fields, and extracting the one or more values from the sensor data based on the one or more fields.

14.The one or more non-transitory computer-readable media of any of clauses 11-13, wherein computing the one or more performance characteristics comprises generating program code, and executing the program code to compute the one or more performance characteristics.

15.The one or more non-transitory computer-readable media of any of clauses 11-14, wherein extracting the one or more values comprises inputting a prompt into the trained machine learning model, and the prompt comprises a description of the sensor data, one or more rules specifying how terms in the documentation are translated into fields in the sensor data, and an instruction to use the documentation to determine one or more fields in the sensor data for extracting the one or more values.

16.The one or more non-transitory computer-readable media of any of clauses 11-15, instructions that, when executed by at least one processor, cause the at least one processor to perform the steps of interpolating, by the trained machine learning model, at least two values in the sensor data.

17.The one or more non-transitory computer-readable media of any of clauses 11-16, wherein the mechanical system comprises an unmanned ariel vehicle.

18.The one or more non-transitory computer-readable media of any of clauses 11-17, instructions that, when executed by at least one processor, cause the at least one processor to perform the steps of generating, via the trained machine learning model, a graphical representation of the one or more performance characteristics.

19.The one or more non-transitory computer-readable media of any of clauses 11-18, instructions that, when executed by at least one processor, cause the at least one processor to perform the steps of detecting one or more anomalies based on the one or more performance characteristics.

20.In some embodiments, a system comprises a memory storing instructions, and one or more processors, that when executing the instructions, are configured to perform the steps of receiving sensor data that includes one or more measurements of a mechanical system, extracting, via a trained machine learning model, one or more values from the sensor data based on documentation associated with the mechanical system, and computing, via the trained machine learning model and based on the one or more values, one or more performance characteristics of the mechanical system.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for characterizing performance of mechanical systems, the method comprising:
receiving sensor data that includes one or more measurements of a mechanical system;
extracting, via a trained machine learning model, one or more values from the sensor data based on documentation associated with the mechanical system; and
computing, via the trained machine learning model and based on the one or more values, one or more performance characteristics of the mechanical system.

2. The computer-implemented method of claim 1, further comprising receiving a natural language input, wherein extracting the one or more values from the sensor data is further based on the natural language input.

3. The computer-implemented method of claim 1, wherein extracting the one or more values comprises:
retrieving one or more terms from the documentation based on natural language input;
translating the one or more terms into one or more fields; and
extracting the one or more values from the sensor data based on the one or more fields.

4. The computer-implemented method of claim 1, wherein computing the one or more performance characteristics comprises:
generating program code; and
executing the program code to compute the one or more performance characteristics.

5. The computer-implemented method of claim 1, wherein extracting the one or more values comprises inputting a prompt into the trained machine learning model, and wherein the prompt comprises a description of the sensor data, one or more rules specifying how terms in the documentation are translated into fields in the sensor data, and an instruction to use the documentation to determine one or more fields in the sensor data for extracting the one or more values.

6. The computer-implemented method of claim 1, further comprising interpolating, by the trained machine learning model, at least two values in the sensor data.

7. The computer-implemented method of claim 1, wherein the one or more performance characteristics include a performance envelope.

8. The computer-implemented method of claim 1, wherein the documentation specifies one or more units for one or more measurements.

9. The computer-implemented method of claim 1, further comprising retrieving, by the trained machine learning model, one or more theoretical performance characteristics.

10. The computer-implemented method of claim 1, wherein the trained machine learning model comprises a trained large language model (LLM).

11. One or more non-transitory computer-readable media storing instructions that, when executed by at least one processor, cause the at least one processor to perform the steps of:
receiving sensor data that includes one or more measurements of a mechanical system;
extracting, via a trained machine learning model, one or more values from the sensor data based on documentation associated with the mechanical system; and
computing, via the trained machine learning model and based on the one or more values, one or more performance characteristics of the mechanical system.

12. The one or more non-transitory computer-readable media of claim 11, wherein the instructions, when executed by the at least one processor, further cause the at least one processor to perform the step of receiving a natural language input, wherein extracting the one or more values from the sensor data is further based on the natural language input.

13. The one or more non-transitory computer-readable media of claim 11, wherein extracting the one or more values comprises:
retrieving one or more terms from the documentation based on natural language input;
translating the one or more terms into one or more fields; and
extracting the one or more values from the sensor data based on the one or more fields.

14. The one or more non-transitory computer-readable media of claim 11, wherein computing the one or more performance characteristics comprises:
generating program code; and
executing the program code to compute the one or more performance characteristics.

15. The one or more non-transitory computer-readable media of claim 11, wherein extracting the one or more values comprises inputting a prompt into the trained machine learning model, and the prompt comprises a description of the sensor data, one or more rules specifying how terms in the documentation are translated into fields in the sensor data, and an instruction to use the documentation to determine one or more fields in the sensor data for extracting the one or more values.

16. The one or more non-transitory computer-readable media of claim 11, instructions that, when executed by at least one processor, cause the at least one processor to perform the steps of interpolating, by the trained machine learning model, at least two values in the sensor data.

17. The one or more non-transitory computer-readable media of claim 11, wherein the mechanical system comprises an unmanned ariel vehicle.

18. The one or more non-transitory computer-readable media of claim 11, instructions that, when executed by at least one processor, cause the at least one processor to perform the steps of generating, via the trained machine learning model, a graphical representation of the one or more performance characteristics.

19. The one or more non-transitory computer-readable media of claim 11, instructions that, when executed by at least one processor, cause the at least one processor to perform the steps of detecting one or more anomalies based on the one or more performance characteristics.

20. A system, comprising:
a memory storing instructions; and
one or more processors, that when executing the instructions, are configured to perform the steps of:
receiving sensor data that includes one or more measurements of a mechanical system,
extracting, via a trained machine learning model, one or more values from the sensor data based on documentation associated with the mechanical system, and
computing, via the trained machine learning model and based on the one or more values, one or more performance characteristics of the mechanical system.
